(19) United States
(12) Patent Application Publication
(10) Pub. No.: US 2018/0054829 A1
(43) Pub. Date: Feb. 22, 2018

(54) Method and Apparatus for Scheduling Resources

(71) Applicant: Telefonaktiebolaget LM Ericsson (publ), Stockholm (SE)

(72) Inventors: Rui FAN, BEIJING (CN); Qianxi LU, BEIJING (CN); Mattias TAN BERGSTRÖM, STOCKHOLM (SE)

(73) Assignee: Telefonaktiebolaget LM Ericsson (publ), Stockholm (SE)

(21) Appl. No.: 15/564,271

(22) PCT Filed: Mar. 3, 2016
(86) PCT No.: PCT/CN2016/075479

§ 371 Date: Oct. 4, 2017

(30) Foreign Application Priority Data
Apr. 9, 2015 (CN) PCT/CN2015/076160

(51) Int. Cl. H04W 72/12

(52) U.S. Cl. CPC H04W 72/1242

(57) ABSTRACT

Embodiments of the invention generally relate to scheduling in a communication network. The base station may receive a first scheduling request for transmission of first information and a second scheduling request for transmission of second information, wherein the first scheduling request is associated with a first priority and the second scheduling request is associated with a second priority. The base station may prioritize scheduling of the transmission of the first information over scheduling of the transmission of the second information in response to the first priority being higher than the second priority. In this way, the scheduling by the base station may be more effective and efficient.

### TECHNICAL FIELD

Embodiments of the present invention generally relate to the field of communications, and more particularly to a method and apparatus for scheduling resources in a communication network.

### BACKGROUND

In a cellular communication, third Generation Partnership (3GPP) Long Term Evolution (LTE) brings increasing demand for wireless broadband data. Many frequency bands have been licensed exclusively for cellular networks in order to meet such demand and provide seamless coverage. By careful planning and deployment of network nodes and elements in the cellular networks, high reliability of communication may be achieved. However, bandwidth requirements from users continue to increase, in particular, in traffic-prone buildings or hot spots. A concept directed to the increasing bandwidth requirements is to extend the frequency spectrum to include unlicensed spectrum, which may be efficient complements of licensed frequency.

In LTE Release 13 (Rel-13), major effort has recently been paid to the development of Further Enhancement of Carrier Aggregation (FeCA), which is concentrated on support carrier aggregation of more than five carriers. As used herein, the term “carrier” refers to a band unit, which, for example, has a bandwidth of 1.4, 3, 5, 10, 15 or 20 MHz in a LTE system. User equipment (UE) supportive of the carrier aggregation can transmit information on multiple aggregated carriers.

At present, the carrier aggregation in FeCA only relates to licensed carriers. In the aggregated licensed carriers, one carrier may be used as a primary carrier, and the others may be used as secondary carriers. When the UE wants to initiate transmission and thus requests scheduling by eNodeB (eNB), it transmits a scheduling request (SR) to the eNB on the primary carrier. Currently, it is also considered to introduce an unlicensed carrier into the carrier aggregation in FeCA in order to augment service spectrum. However, there is no SR transmission scheme in such an application scenario.

### SUMMARY

Generally, embodiments of the present invention provide an efficient solution for scheduling by the base station.

In a first aspect, a method in a base station is provided. The method comprises: receiving a first scheduling request for transmission of first information, the first scheduling request being associated with a first priority; receiving a second scheduling request for transmission of second information, the second scheduling request being associated with a second priority; and in response to the first priority being higher than the second priority, prioritizing scheduling of the transmission of the first information over scheduling of the transmission of the second information. The corresponding computer program is also provided.

In some embodiments, prioritizing the scheduling of the transmission of the first information over the scheduling of the transmission of the second information may comprise: prioritizing selection of a primary carrier for the transmission of the first information.

In some embodiments, prioritizing the scheduling of the transmission of the first information over the scheduling of the transmission of the second information may comprise: prioritizing selection of a licensed carrier for the transmission of the first information.

In some embodiments, prioritizing the scheduling of the transmission of the first information over the scheduling of the transmission of the second information may comprise: scheduling the transmission of the first information earlier than the transmission of the second information.

In some embodiments, prioritizing the scheduling of the transmission of the first information over the scheduling of the transmission of the second information may comprise: selecting a lower order modulation for the transmission of the first information than the transmission of the second information.

In some embodiments, prioritizing the scheduling of the transmission of the first information over the scheduling of the transmission of the second information may comprise: selecting a higher coding rate for the transmission of the first information than the transmission of the second information.

In some embodiments, prioritizing the scheduling of the transmission of the first information over the scheduling of the transmission of the second information may comprise: allocating more resources for the transmission of the first information than the transmission of the second information.

In a second aspect, an apparatus in a base station is provided. The apparatus comprising: a receiving unit configured to receive a first scheduling request for transmission of first information and a second scheduling request for transmission of second information, the first scheduling request being associated with a first priority, the second scheduling request being associated with a second priority; and a scheduling unit configured to prioritize scheduling of the transmission of the first information over scheduling of the transmission of the second information in response to the first priority being higher than the second priority.

In a third aspect, a base station is provided. The base station comprises a processor and a memory including computer-executable instructions which, when executed by the processor, cause the base station to: receive a first scheduling request for transmission of first information, the first scheduling request being associated with a first priority; receive a second scheduling request for transmission of second information, the second scheduling request being associated with a second priority; and in response to the first priority being higher than the second priority, prioritize scheduling of the transmission of the first information over scheduling of the transmission of the second information.

In a fourth aspect, a base station is provided. The base station comprises processing means adapted to: receive a first scheduling request for transmission of first information, the first scheduling request being associated with a first priority; receive a second scheduling request for transmission of second information, the second scheduling request being associated with a second priority; and in response to the first priority being higher than the second priority, prioritize scheduling of the transmission of the first information over scheduling of the transmission of the second information.

According to embodiments of the present invention, the BS may be aware of the priority associated with a SR and therefore prioritize the scheduling for the SR associated with the high priority. In this way, the scheduling by the BS may be more effective and efficient.

### BRIEF DESCRIPTION OF THE DRAWINGS

The above and other aspects, features, and benefits of various embodiments of the disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 illustrates an environment of a communication network in which embodiments of the present invention may be implemented;

FIG. 2 illustrates a flowchart of a method for scheduling in accordance with one embodiment of the present invention;

FIG. 3 illustrates a block diagram of an apparatus for scheduling in accordance with one embodiment of the present invention; and

FIG. 4 illustrates a simplified block diagram of an apparatus that is suitable for use in implementing embodiments of the present invention.

### DETAILED DESCRIPTION

The present invention will now be discussed with reference to several example embodiments. It should be understood that these embodiments are discussed only for the purpose of enabling those skilled persons in the art to better understand and thus implement the present invention, rather than suggesting any limitations on the scope of the present invention.

As used herein, the term “base station” (BS) may be referred to as eNB, eNodeB, NodeB or base transceiver station (BTS) and the like depending on the technology and terminology used, which may configure/de-configure and activate/de-activate secondary cells and schedule resources on the secondary cells, for example. The term “terminal device” or “user equipment” (UE) refers to any terminal having wireless communication capabilities, including but not limited to, mobile phones, cellular phones, smart phones, or personal digital assistants (PDAs), portable computers, image capture devices such as digital cameras, gaming devices, music storage and playback appliances, and any portable units or terminals that have wireless communication capabilities, or Internet appliances permitting wireless Internet access and browsing and the like. In the context of the present invention, the terms “base station” or “BS” and “eNodeB” or “eNB” may be used interchangeably hereinafter, and the terms “user equipment” or “UE” and “terminal device” may be used interchangeably.

As used herein, the singular forms “a”, “an” and “the” are intended to include the plural forms as well, unless the context clearly indicates otherwise. The terms “comprises,” “comprising,” “has,” “having,” “includes” and/or “including” as used herein, specify the presence of stated features, elements, and/or components and the like, but do not preclude the presence or addition of one or more other features, elements, components and/or combinations thereof. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

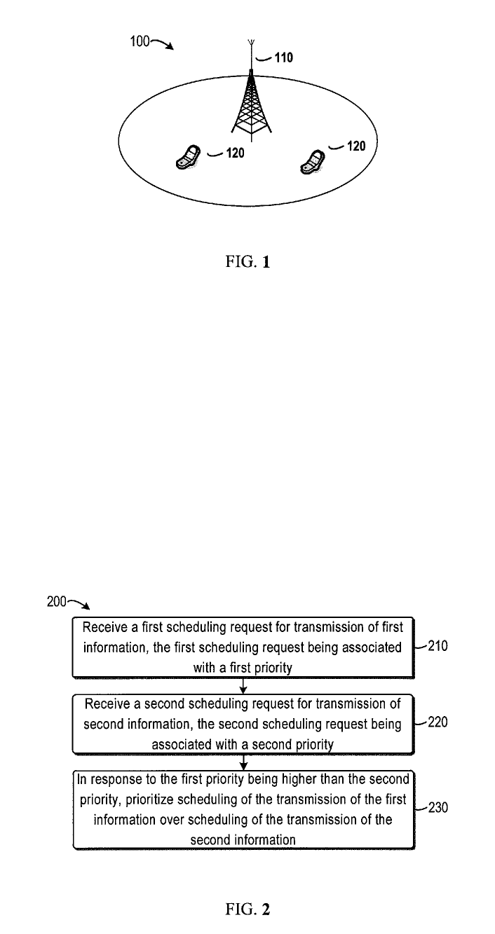

FIG. 1 shows an environment of a communication network 100 in which embodiments of the present invention may be implemented. As shown, two or more terminal devices 120 may communicate with one or more BSs 110. In this example, there are two terminal devices 120 and one BS 110. This is only for the purpose of illustration without suggesting the limitations on the number of the terminal devices 120 and the BSs 110. There may be any suitable number of the terminal devices 120 in communication with the BS 110.

The communications between the terminal devices 120 and the BS 110 may be performed according to any suitable communication protocols including, but not limited to, the first generation (1G), the second generation (2G), 2.5G, 2.75G, the third generation (3G), the fourth generation (4G) communication protocols, 4.5G, and/or any other protocols either currently known or to be developed in the future.

If the terminal device 120 wants to initiate information transmission, it will transmit a SR to the BS 110. In the context of the present invention, the term “information” refers to any type of information. For example, the information may include controlling signaling and payload related to any type of traffic, such as voice traffic, data traffic, Short Messaging Service (SMS) and the like. After receiving the SR from the terminal device 110, the BS 120 may schedule the resources for the transmission of the terminal device 110, and then send a grant to the terminal device 110. Next, the terminal device 110 may transmit the information based on the scheduling by the BS 120.

In a conventional approach, the SR may only indicate that the terminal device wants to initiate the transmission and can indicate nothing else. Accordingly, after the BS receives a plurality of SRs, the BS may not distinguish the SRs and offer different scheduling for different SRs.

FIG. 2 shows a flowchart of a method 200 for scheduling in accordance with one embodiment of the present invention. It would be appreciated that the method 200 may be implemented in the BS 110 as shown in FIG. 1.

As shown, the method 200 is entered at step 210, where the BS 110 receives a first SR for transmission of first information, wherein the first SR is associated with a first priority. Then, at step 220, the BS 110 receives a second SR for transmission of second information, wherein the second SR is associated with a second priority. According to embodiments of the present invention, the first and second SRs may be received from one terminal device or two terminal devices.

It should be appreciated that the two SRs may be received by the BS 110 in any suitable order. It should also be appreciated that the priority of the SR may be based on any suitable priority rules. The scope of the present invention will not be limited in this regard. According to embodiments of the present invention, based on the priorities associated with the received SRs, the BS 110 may distinguish the SRs and therefore offer different scheduling for the different SRs.

Then, the method 200 proceeds to step 220, where, in response to the first priority being higher than the second priority, the BS 110 prioritizes scheduling of the transmission of the first information associated with the first priority compared with the transmission of the second information associated with the second priority. Thus, the BS 110 may offer a prioritized scheduling for the high-priority SR such that the scheduling by the BS 110 is more effective and efficient.

According to embodiments of the present invention, the BS 110 may use any suitable approaches to offer prioritized scheduling to the high-priority SR. Specifically, in one embodiment, the BS 110 may prioritize selection of certain carriers for the transmission related to the high-priority SR such that the reliability and efficiency of the transmission may be ensured.

As described above, in the LTE system enabling carrier aggregation, a terminal device may be allocated multiple carriers of a licensed band for transmission. Conventionally, the primary carrier from the aggregated carriers may be used by the terminal device to transmit an SR. According to embodiments of the present invention, unlicensed carriers may also be used for carrier aggregation. Accordingly, both a licensed carrier and an unlicensed carrier may act as a primary carrier or a secondary carrier. Furthermore, not only a licensed carrier but also an unlicensed carrier may be used for transmission of the terminal device. In this way, improved coverage and reliable and efficient communications may be achieved by using unlicensed carriers as complements of licensed carriers.

In this case, by way of example, the BS 110 may prioritize the selection of a primary carrier or a licensed carrier for the transmission corresponding to the high-priority SR. Specifically, when the BS 110 receives two SRs which have different priorities, the BS 110 may prioritize allocating the resources on a primary carrier or a licensed carrier for the high-priority SR. It should be understood that a primary carrier or a licensed carrier may provide a higher transmission quality than a secondary carrier or an unlicensed carrier. As a result, the reliability and efficiency of the transmission corresponding to the high-priority SR may be ensured first by prioritize the selection of the primary carrier or the licensed carrier for the high-priority SR.

After the scheduling for the high-priority SR, the BS 110 may flexibly determine the selection of the carrier for the low-priority SR. For example, the BS 110 may select a secondary carrier or an unlicensed carrier for the low-priority SR. Alternatively or additionally, if there are still available resources on the primary carrier or the licensed carrier, the BS 110 may also select the primary carrier or the licensed carrier for the low-priority SR. As another example, if there are no sufficient resources on licensed carrier, the high-priority SR may also be assigned to resources on an unlicensed carrier.

In addition to prioritize the selection of certain carriers, in another embodiment, the BS 110 may prioritize the scheduling for the high-priority SR by scheduling the transmission corresponding to the high-priority SR earlier than the transmission corresponding to the low-priority SR. In this way, the transmission corresponding to the high-priority SR may be earlier and therefore have a shorter delay than the transmission corresponding to the low-priority SR.

In yet another embodiment, the BS 110 may prioritize the scheduling for the high-priority SR by allocating more resources for its corresponding transmission. In this way, it may be ensured that the transmission corresponding to the high-priority SR has sufficient resources for use.

In another embodiment, the BS 110 may prioritize the scheduling for the high-priority SR by selecting a more robust modulation and coding scheme for its corresponding transmission. Specifically, the BS 110 may select a lower order modulation and/or a higher coding rate for the transmission corresponding to the high-priority SR. It should be understood that a low order modulation and/or high coding rate may bring more redundancies to the information to be transmitted and therefore have a high anti-noise-interference performance. As a result, the selection of the lower order modulation and/or higher coding rate may ensure the reliability and efficiency of the transmission that is aimed at by the high-priority SR.

It should be appreciated that regarding the amount of allocated resources, the scheduling for the low-priority SR may be determined by the BS 110 flexibly. For example, if there are sufficient resources, the BS 110 may allocate to the low-priority SR as many resources as the high-priority SR.

According to embodiments of the present invention, various prioritized scheduling approaches for the high-priority SR may be used by the BS 100 separately or in combination. Specifically, the BS 110 may use at least one of the prioritized scheduling approaches as described above to prioritize the scheduling for one SR having a higher priority.

It should be understood that the BS may send to the terminal device a grant for indicating a result of the scheduling. Then, the terminal device may transmit the information based on the scheduling by the BS.

According to embodiments of the present invention, the BS that is aware of a priority of a SR can distinguish different SRs based on their priorities. Accordingly, the BS may offer different scheduling for transmission corresponding to different SRs. In this way, the scheduling by the BS is more effective and efficient.

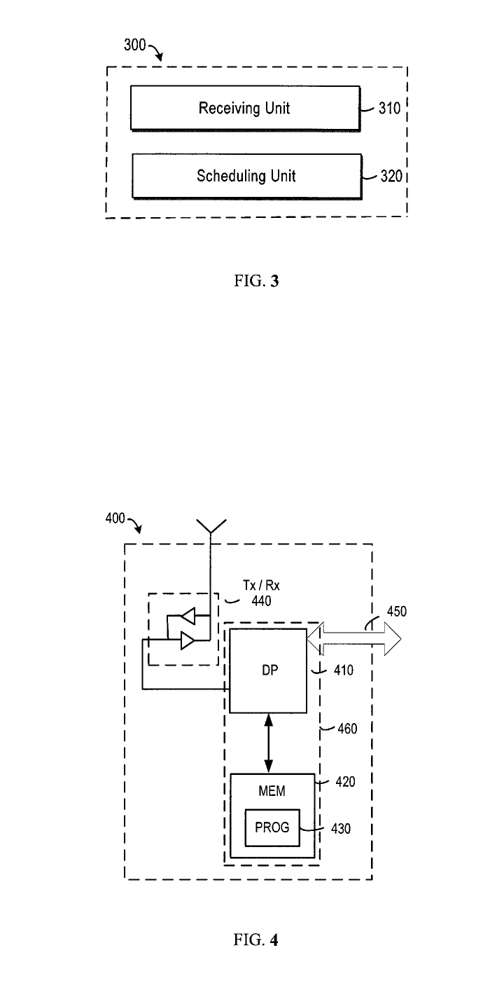

FIG. 3 shows a block diagram of an apparatus 300 for scheduling in accordance with one embodiment of the present invention. It would be appreciated that the apparatus 300 may be implemented by the BS 110 as shown in FIG. 1.

As shown, the apparatus 300 comprises a receiving unit 310 and a scheduling unit 320. The receiving unit 310 is configured to receive a first scheduling request for transmission of first information and a second scheduling request for transmission of second information, the first scheduling request being associated with a first priority, the second scheduling request being associated with a second priority. The scheduling unit 320 is configured to prioritize scheduling of the transmission of the first information over scheduling of the transmission of the second information in response to the first priority being higher than the second priority.

In one embodiment, the scheduling unit 320 may be further configured to prioritize selection of a primary carrier for the transmission of the first information. Alternatively or additionally, in one embodiment, the scheduling unit 320 may be further configured to prioritize selection of a licensed carrier for the transmission of the first information.

In one embodiment, the scheduling unit 320 may be further configured to schedule the transmission of the first information earlier than the transmission of the second information. Alternatively or additionally, in one embodiment, the scheduling unit 320 may be further configured to allocate more resources for the transmission of the first information than the transmission of the second information.

In one embodiment, the scheduling unit 320 may be further configured to select a more robust modulation and coding scheme for the transmission of the first information than the transmission of the second information. Specifically, the scheduling unit 320 may be configured to select a lower order modulation and/or a higher coding rate for the transmission of the first information than the transmission of the second information.

It should be appreciated that units included in the apparatus 300 correspond to the steps of the method 200. Therefore, all operations and features described above with reference to FIG. 2 are likewise applicable to the units included in the apparatus 300 and have similar effects. For the purpose of simplification, the details will be omitted.

The units included in the apparatus 300 may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatus 300 may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

FIG. 4 illustrates a simplified block diagram of an apparatus 400 that is suitable for use in implementing embodiments of the present invention. The apparatus 400 may be implemented in the BS 110 as shown in FIG. 1.

As shown in FIG. 4, the apparatus 400 includes a data processor (DP) 410, a memory (MEM) 420 coupled to the DP 410, a suitable RF transmitter TX and receiver RX 440 coupled to the DP 410, and a communication interface 450 coupled to the DP 410. The MEM 420 stores a program (PROG) 430. The TX/RX 440 is for bidirectional wireless communications. Note that the TX/RX 440 has at least one antenna to facilitate communication, though in practice an Access Node mentioned in this application may have several ones. The communication interface 450 may represent any interface that is necessary for communication with other network elements, such as X2 interface for bidirectional communications between eNBs, S1 interface for communication between a Mobility Management Entity (MME)/Serving Gateway (S-GW) and the eNB, or Un interface for communication between the eNB and a relay node (RN). The apparatus 400 may be coupled via a data path to one or more external networks or systems, such as the internet, for example. The Serving Gateway may be the L-GW and the eNB may be the Access Node.

The PROG 430 is assumed to include program instructions that, when executed by the associated DP 410, enable the apparatus 400 to operate in accordance with the embodiments of the present invention, as discussed herein with the method 200 in FIG. 2.

The embodiments herein may be implemented by computer software executable by the DP 410 of the apparatus 400, or by hardware, or by a combination of software and hardware.

A combination of the data processor 410 and MEM 420 may form processing means 460 adapted to implement various embodiments of the present invention.

The MEM 420 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the apparatus 400, there may be several physically distinct memory modules in the apparatus 400. The DP 410 may be of any type suitable to the local technical environment, and may include one or more of general purpose computers, special purpose computers, microprocessors, digital signal processors (DSPs) and processors based on multicore processor architecture, as non-limiting examples. The apparatus 400 may have multiple processors, such as an application specific integrated circuit chip that is slaved in time to a clock which synchronizes the main processor.

Generally, various embodiments of the present invention may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present invention are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the present invention can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present invention may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this invention, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present invention, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present invention has been described in language specific to structural features and/or methodological acts, it is to be understood that the present invention defined in the appended claims is not necessarily limited to the specific features or acts described above. Rather, the specific features and acts described above are disclosed as example forms of implementing the claims.

1. A method in a base station, comprising:
receiving a first scheduling request for transmission of first information, the first scheduling request being associated with a first priority;
receiving a second scheduling request for transmission of second information, the second scheduling request being associated with a second priority; and
in response to the first priority being higher than the second priority, prioritizing scheduling of the transmission of the first information over scheduling of the transmission of the second information.

2. The method according to claim 1, wherein prioritizing the scheduling of the transmission of the first information over the scheduling of the transmission of the second information comprises:
prioritizing selection of a primary carrier for the transmission of the first information.

3. The method according to claim 2, wherein prioritizing the scheduling of the transmission of the first information over the scheduling of the transmission of the second information comprises:
prioritizing selection of a licensed carrier for the transmission of the first information.

4. The method according to claim 1, wherein prioritizing the scheduling of the transmission of the first information over the scheduling of the transmission of the second information comprises:
scheduling the transmission of the first information earlier than the transmission of the second information.

5. The method according to claim 1, wherein prioritizing the scheduling of the transmission of the first information over the scheduling of the transmission of the second information comprises:
selecting a lower order modulation for the transmission of the first information than the transmission of the second information.

6. The method according to claim 1, wherein prioritizing the scheduling of the transmission of the first information over the scheduling of the transmission of the second information comprises:
selecting a higher coding rate for the transmission of the first information than the transmission of the second information.

7. The method according to claim 1, wherein prioritizing the scheduling of the transmission of the first information over the scheduling of the transmission of the second information comprises:
allocating more resources for the transmission of the first information than the transmission of the second information.

8. An apparatus in a base station, comprising:
a receiver configured to receive a first scheduling request for transmission of first information and a second scheduling request for transmission of second information, the first scheduling request being associated with a first priority, the second scheduling request being associated with a second priority; and
one or more processors configured to prioritize scheduling of the transmission of the first information over scheduling of the transmission of the second information in response to the first priority being higher than the second priority.

9. The apparatus according to claim 8, wherein the one or more processors are further configured to prioritize selection of a primary carrier for the transmission of the first information.

10. The apparatus according to claim 9, wherein the one or more processors are further configured to prioritize selection of a licensed carrier for the transmission of the first information.

11. The apparatus according to claim 8, wherein the one or more processors are further configured to schedule the transmission of the first information earlier than the transmission of the second information.

12. The apparatus according to claim 8, wherein the one or more processors are further configured to select a lower order modulation for the transmission of the first information than the transmission of the second information.

13. The apparatus according to claim 8, wherein the one or more processors are further configured to select a higher coding rate for the transmission of the first information than the transmission of the second information.

14. The apparatus according to claim 8, wherein the one or more processors are further configured to allocate more resources for the transmission of the first information than the transmission of the second information.

15. A base station, comprising:
a processor; and
a memory including computer-executable instructions which, when executed by the processor, cause the base station to:
receive a first scheduling request for transmission of first information, the first scheduling request being associated with a first priority;
receive a second scheduling request for transmission of second information, the second scheduling request being associated with a second priority; and
in response to the first priority being higher than the second priority, prioritize scheduling of the transmission of the first information over scheduling of the transmission of the second information.
